(19) United States
(12) Patent Application Publication
(10) Pub. No.: US 2013/0049929 A1
(43) Pub. Date: Feb. 28, 2013

(54) DIAGNOSTIC METHOD AND SYSTEM FOR WIRELESS DOOR CONTROL SYSTEMS

(71) Applicant: Frank Gerlach, Mississauga (CA)

(72) Inventor: Frank Gerlach, Mississauga (CA)

(21) Appl. No.: 13/521,207

(22) PCT Filed: Jan. 14, 2011
(86) PCT No.: PCT/CA11/00039

§ 371 Date: Aug. 8, 2012

(30) Foreign Application Priority Data
Jan. 14, 2010 (CA) 2,717,445

(51) Int. Cl. G05B 19/00

(52) U.S. Cl. 340/5.64

(57) ABSTRACT

A diagnostic method and system for wireless door control systems comprising transmitters and a receiver which transmit diagnostic information to a diagnostic device which conveys diagnostic information about the system to the user. The diagnostic device may also facilitate selective enrollment and/or disassociation of transmitters, loading firmware into receivers, overriding hardware settings, interrogating receivers and/or transmitters, emulating devices, testing battery conditions, testing frequency bands for interference and other functions.

### FIELD OF THE INVENTION

This invention relates to control systems. In particular, this invention relates to wireless door control systems.

### BACKGROUND

In wireless door control systems, for example for accessibility doors allowing ingress into or egress from a premises, a door is automatically opened or released in response to a receiver receiving a signal from a transmitter.

The transmitter may be installed at a fixed location, such as in a wall, or may be mobile, for example contained in a key fob. When a transmitter switch (for example, a ‘mushroom’ switch, a key fob switch or the like) is depressed, the transmitter wirelessly transmits a signal containing a preset Unique Identifier code (UID) which is received by the receiver associated with the door to be opened, thus activating the door control system. Optionally, lot code and transmitter switch setting information may also be transmitted along with the UID. Each manufactured transmitter has its own UID programmed at the factory or has a facility for setting the UID with a plurality of switches (e.g. dip switches). In this fashion any number of doors, regardless of their proximity to one another, may each be equipped with a wireless door control system which actuates only the door with which the particular transmitter is associated.

The receiver is installed at or near the operated door(s) (typically in the metal frame surrounding the door) for receiving transmissions from the transmitter. If the UID in the received signal is recognized, a control step for operating doors or turnstiles (for example, ‘open’ or ‘release’) is initiated.

The receiver may be programmed to recognize (i.e. enroll) multiple transmitters, for example 20 transmitters each having its own unique UID, such that the receiver will respond to any of the 20 transmitters. Typically receivers have a “push and learn” feature whereby a receiver is put into learn mode, for example by depressing a push-button for a specified interval such as three seconds, at which time an LED indicator may flash three times to indicate that the receiver has entered the learn mode.

Thus, examples of common Human Machine Interface (HMI) or user interface features of a receiver include switches (such as push-buttons) used for learning transmitter codes, dip switches for controlling the mode of an installation, and Light Emitting Diodes (LEDs) for flashing feedback parameters to an installer indicating setup conditions.

In the learn mode, the receiver enrolls a transmitter's UID when the transmitter switch is depressed, by storing the transmitted UID. After a preset time delay or other means of returning to operational mode, in normal operation the door control will activate in response to receiving each learned transmitter UID. However, all learned UIDs may be erased when the push-button is held for some longer interval, for example five seconds. Thus, accidentally holding down a push-button for too long in an attempt to go into learn mode may inadvertently erase (i.e. disassociate) all stored UIDs. Furthermore, in conventional door control systems the only way to erase a particular UID is to erase all stored UIDs and then reprogram all the required UIDs through the learn mode.

Wireless signals from a transmitter may be attenuated or lost by the time it reaches a receiver, particularly where the receiver is mounted within a metal door frame. However, prior to and during installation of the door control system, there is no way of knowing if a transmitter is working properly, or whether the receiver is receiving a marginal signal, a poor signal or a strong signal. Installations of such wireless door control systems are therefore completed blindly, and the quality of an installation is unknown until completion. The only way to determine that an installation is working properly is to test its operation after completion of the installation by operating a recognized transmitter. If the door activates from the required range, then the installation is considered to have been successful.

Troubleshooting an installation that does not work properly can be a time consuming task, and can increase the safety risk to the installer who might have to climb a ladder and reopen the installation to access the receiver and/or transmitter to improve its functioning.

### BRIEF DESCRIPTION OF THE DRAWINGS

In drawings which illustrate by way of example only a preferred embodiment of the invention,

FIG. 1 is a schematic diagram of an embodiment of a wireless door control system according to the invention;

FIG. 2 is a schematic diagram of an alternate embodiment of a wireless door control system according to the invention;

FIG. 3 is a block diagram of an embodiment of transmitter for a wireless door control system according to the invention;

FIG. 4 is a block diagram of an embodiment of a receiver for a wireless door control system according to the invention;

FIG. 5 is a block diagram of an embodiment of a diagnostic device for a wireless door control system according to the invention;

FIG. 6A is a timing diagram for the wireless door control system of FIG. 1 activated by a diagnostics-enabled transmitter;

FIG. 6B is a timing diagram for the wireless door control system of FIG. 1 activated by a conventional transmitter;

FIG. 6C is a timing diagram for operation of the wireless door control system of FIG. 2;

FIG. 7A is a timing diagram for enrolling a diagnostics-enabled transmitter in the wireless door control system of FIG. 1;

FIG. 7B is a timing diagram for transmitter emulation by the diagnostic device in the wireless door control system of FIG. 1;

FIG. 8A is a timing diagram for receiver diagnostic inquiry by the diagnostic device in the wireless door control system of FIG. 1;

FIG. 8B is a timing diagram for updating receiver firmware in the wireless door control system of FIG. 1;

FIG. 9A is a timing diagram for enrolling a conventional transmitter in the wireless door control system of FIG. 1; and,

FIG. 9B is a timing diagram for disassociating a transmitter UID in the wireless door control system of FIG. 1.

### DETAILED DESCRIPTION OF THE INVENTION

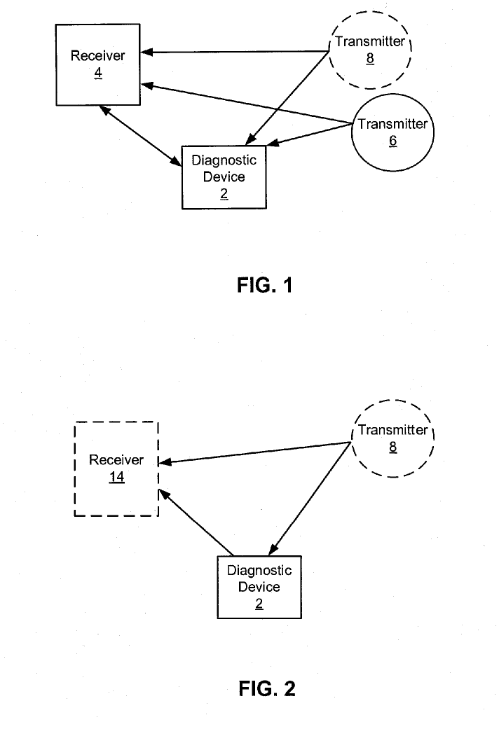

FIG. 1 illustrates an embodiment of a wireless door control system comprising one or more diagnostics-enabled transmitters 6 and a diagnostics-enabled receiver 4. This embodiment may optionally comprise one or more conventional transmitters 8. The conventional transmitters 8 transmit a primary signal that includes their UID, whereas diagnostics-enabled transmitters 6 additionally transmit a secondary signal containing diagnostic information described in detail below. The diagnostics-enabled receiver 4 is preferably a transceiver for receiving signals from the one or more transmitters 6 and optionally transmitters 8, and for transmitting and receiving signals to and from a diagnostic device 2.

FIG. 2 illustrates another embodiment of a wireless door control system comprising conventional transmitters 8 and a conventional receiver 14. Unlike the diagnostics-enabled receiver 4, the conventional receiver 14 is not configured to transmit signals containing diagnostic information to a diagnostic device 2.

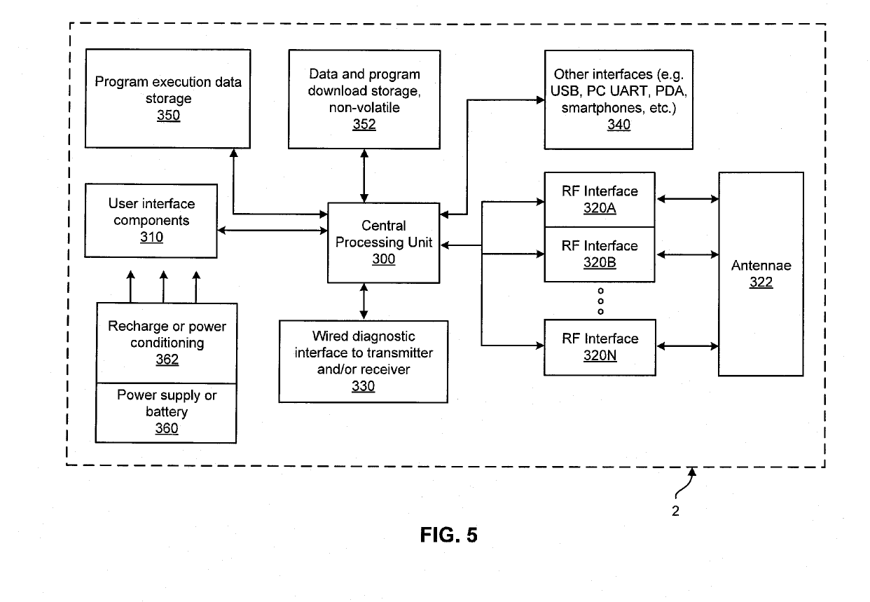

FIG. 5 is a block diagram of an exemplary embodiment of a diagnostic device 2. The diagnostic device 2 may receive signals from the transmitters 6, 8 and may transmit and receive signals containing diagnostic information to and from the receiver 4. The diagnostic device 2 described herein is preferably (but not necessarily) mobile, and provides users with a means for accessing operating information about a wireless door control system and configuring the system.

The diagnostic device 2 comprises a central processing unit 300, which may for example be a Microchip™ dsPIC33FJ256GP710, which controls the overall operation of the diagnostic device 2. The diagnostic device 2 may also include an operating system and software components executed by the central processing unit 300. The operating system and software components are typically stored in a non-volatile store 352 such as flash memory, read-only memory (ROM) or similar storage element. Those skilled in the art will appreciate that portions of the operating system and the software components, such as specific device program applications, or parts thereof, or data generated during execution of an application can be loaded into program execution data storage 350, which may comprise non-volatile memory, such as flash memory, and/or volatile memory, such as random access memory (RAM). For example, a new software application (considered in this example to be the data) to be loaded into the receiver 4 may first be downloaded to the program execution data storage 350 of the diagnostic device 2 from the Internet via any interface 330 or 340 (described in greater detail below). Other data generated during the execution of an application may be stored in RAM. Many different software components may be included, as is well known to those skilled in the art.

The diagnostic device 2 also includes user interface subsystems 310, which interact with the central processing unit 300. User interface subsystems 310 allow a user to select, control and activate functions of the diagnostic device 2 and may include a screen for displaying content within a graphical user interface, light emitting diode (LED) indicators, a speaker and/or headphones or earphones for generating sounds audible to the user, a vibratory interface for generating human-perceptible vibrations, buttons, switches, a keyboard or keypad, auxiliary input/output interfaces, or any combination thereof.

The diagnostic device 2 may include one or more radio frequency (RF) interfaces 320 which interact with the central processing unit 300, and one or more antennae 322 for receiving signals from the transmitters 6, 8 and receiver 4, and transmitting signals to the receiver 4 or 14. Several RF interfaces 320A-320N may be used to support a plurality of transmission and reception frequencies.

As will be appreciated by those skilled in the art, signals transmitted and received by the diagnostic device 2 may be in any suitable frequency band, using any suitable modulation scheme. For example, the signals may be modulated by on-off shift key (OOSK) modulation, frequency modulation (FM), quadrature phase-shift key (QPSK) modulation, amplitude modulation (AM) or modulated according to any other modulation scheme. Also, the diagnostic device 2 may accommodate single-frequency or multiple concurrent frequency systems, frequency hopping systems, direct sequence systems, hybrid spread spectrum systems and any other suitable system.

The wireless interface may comprise components for standardized short-range communication. Examples of short-range communication standards include standards developed by the Infrared Data Association (IrDA), Bluetooth™, ZigBee™ and the 802.11™ family of standards developed by IEEE, or any other suitable wireless communication scheme.

A wired diagnostic interface 330 that interacts with the central processing unit 300 may also optionally be provided for wired connection to a transmitter 6 and/or receiver 4. Other interfaces 340 may be provided for communication with devices such as data communication devices or data processing devices, which may be capable of communicating over a network, portable and/or wirelessly enabled, including without limitation cellular phones, smartphones, wireless organizers, personal digital assistants, desktop computers, terminals, laptops, tablets, handheld wireless communication devices, wirelessly-enabled notebook computers and the like. The diagnostic device 2 may communicate with such other devices via a wired or wireless interface.

Interfaces 330 or 340 for wired connections may comprise one or more data ports, which provide for information or software downloads to or from the diagnostic device 2. In some embodiments the data port can be a USB port which includes data lines for data transfer and a supply line that can provide a charging current to charge the battery 360 of the diagnostic device 300. In other embodiments the data port can be an Ethernet port or any other suitable serial or parallel port. Other interfaces 340 may comprise a universal asynchronous receiver transmitter (UART).

The signals transmitted to and received by the diagnostic device 2 and/or the information contained in those signals may be encrypted or not encrypted (i.e. secure or not secure). For example, the secondary signal transmitted by the transmitter 6 containing diagnostic information may be encrypted, while the primary transmission containing the UID may not be encrypted. In this embodiment, the diagnostic device 2 would be configured to decrypt the secondary signal. The diagnostic device 2 may therefore include an encoder and/or decoder, either or both of which may be hardware- or software-based, for encrypting and decrypting some or all of the signals transmitted and received. Any encryption standard may be used, such as Data Encryption Standard (DES), Triple DES, or Advanced Encryption Standard (AES).

The diagnostic device 2 may be powered by battery and/or another power supply 360, such as AC power from a power utility via an adapter. Battery-powered embodiments preferably include a battery interface for coupling to one or more rechargeable batteries. The battery or other power supply 360 is preferably coupled to a power conditioning module 362, which may comprise a regulator. In embodiments in which the diagnostic device 2 is capable of being powered by both a battery and a secondary power supply (not shown), the power conditioning module 362 may also facilitate recharging of the battery when the other power supply and the battery are simultaneously connected to the diagnostic device 2.

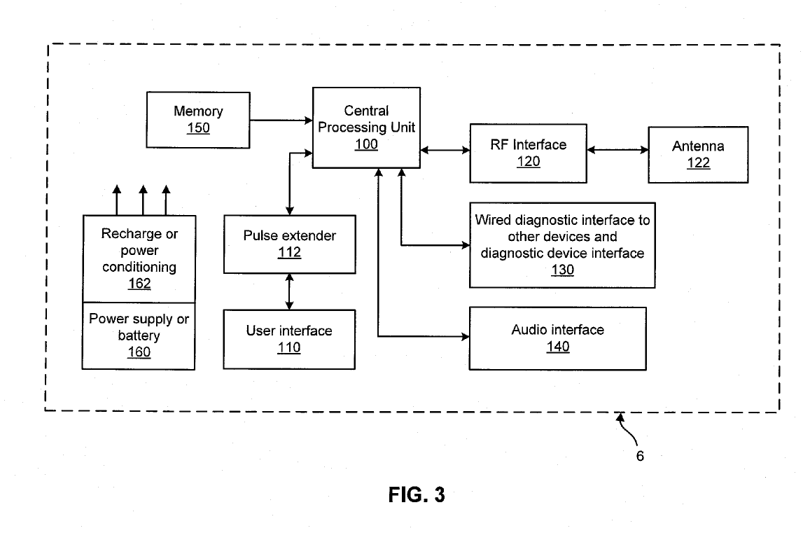

FIG. 3 illustrates an exemplary embodiment of a diagnostics-enabled transmitter 6. The transmitter 6 comprises a central processing unit 100, which may for example be a Microchip™ 16F688 that controls the overall operation of the transmitter 6. The central processing unit 100 may process application programs stored in memory 150 and cause program execution data to be stored in memory 150. Memory 150 may include a non-volatile store such as flash memory and/or a volatile store such as RAM. The transmitter 6 also includes a user interface 110 allowing a user to interact with the transmitter 6, an RF interface 120 and an antenna 122 for transmission of signals to the receiver 4 or the diagnostic device 2. The user interface 110 may interact with the central processing unit 100 via a pulse extender 112 to facilitate detection of user input. The user interface 110 may comprise one or more LED indicators and one or more push-buttons, including a main push-button switch. Activation of the main push-button switch causes the transmitter 6 to transmit a wireless primary signal containing at least the transmitter's UID and a secondary signal containing diagnostic information.

The diagnostic information may include the number of operations or cycles of the transmitter 6, battery life and/or remaining battery life, temperature conditions of the transmitter 6, timeout conditions, error codes, and any other diagnostic information as desired. The diagnostic information may optionally be secured by encryption, as described above.

The transmitter 6 may also comprise one or more wired diagnostic interfaces 130 for wired connections to the diagnostic device 2 or other devices. Like the interfaces 330 or 340 of the diagnostic device 2, these wired diagnostic interfaces 130 may comprise data ports, such as a USB port, an Ethernet port, or any other suitable serial or parallel port.

The transmitter 6 may be powered by battery and/or another power supply 160, such as AC power from a power utility via an adapter, which may be coupled to a power conditioning module 162 as described above. Typically the transmitter in automatic door control systems would be powered by disposable batteries of a convenient and readily available size, such as ‘AAA’ batteries.

The transmitter 6 may also include an audio interface 140 for annunciation of diagnostic codes or other information. The audio interface 140 may comprise an audio transducer such as a speaker or piezoelectric element for generating sounds audible to the user. As an example, the transmitter 6 may be programmed with a battery-tester function to annunciate battery condition through a series of tones or beeps when a push-button on the transmitter is held down for a preset interval. For example, full battery condition could be indicated by multiple (e.g. three) beeps while a low battery condition could be annunciated with a single beep. Low battery condition can also be annunciated whenever the main push-button switch of the transmitter 6 is activated. The audio transducer may also be employed to indicate a stuck switch and/or to confirm program execution or completion.

In another embodiment, the transmitter 6 may include a transceiver for receiving signals from the diagnostic device 2 or another device in a manner similar to the embodiment of the receiver 4.

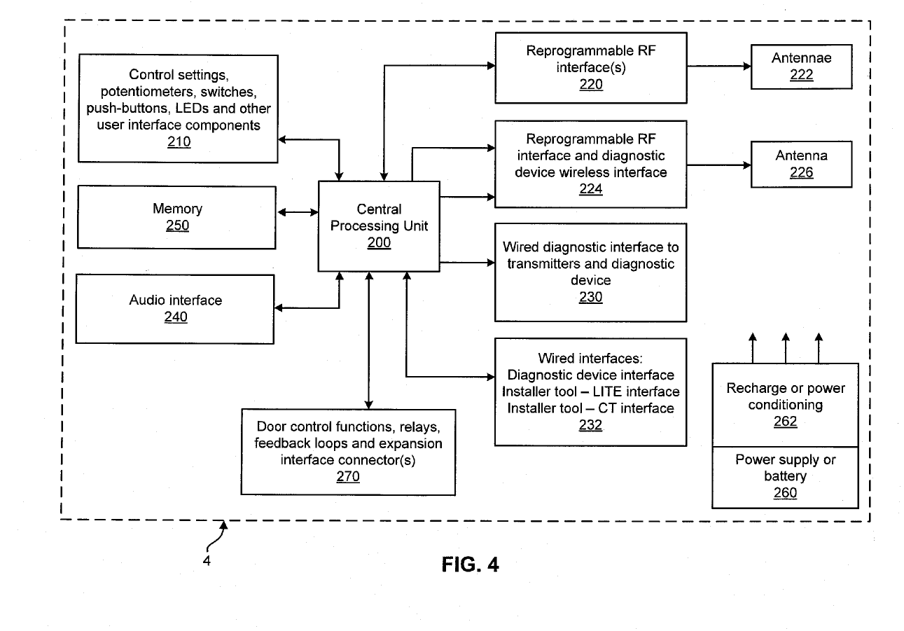

FIG. 4 illustrates an exemplary embodiment of a diagnostics-enabled receiver 4, preferably comprising a transceiver. The receiver 4 comprises a central processing unit 200, which may for example be a Microchip™ 18F46K40, which controls the overall operation of the receiver 4. The central processing unit 200 may process application programs stored in memory 250 and cause program execution data to be stored in memory 250. Memory 250 may include a non-volatile store such as flash memory and/or a volatile store such as RAM. The receiver 6 also comprises user interface components 210, preferably including dip switches for the setting of operating parameters, such as relay operating modes; potentiometers for setting delays and other functions such as how long the door should remain open, the time delay between dual doors and the like; relays to activate actuation and/or release of the door; one or more push-buttons for entering programming modes, enrolling transmitters, and other functional modes; and one or more LED indicators for indicating program mode, confirmation of transmitter 6, 8 enrollment, number of transmitters 6, 8 enrolled, transmitter 6, 8 detection for deletion, relay activation, transmitter 6, 8 signal strength, and other control settings. Some user interface components 210 may interact with the central processing unit 200 via pulse extenders (not shown). The receiver 4 may also include feedback loops, such as for a door open sensor, and expansion interface connectors 270.

In this embodiment, the receiver 4 preferably comprises one or more reprogrammable RF interfaces 220 and antennae 222 for receipt of signals from transmitters 6, 8. The receiver 4 also preferably comprises a reprogrammable RF interface 224 and antenna 226 for transmission and receipt of wireless signals to and from the diagnostic device 2.

The receiver 4 may also comprise one or more wired diagnostic interfaces 230 for wired connections to the diagnostic device 2 or one or more transmitters 6, 8, for communication of diagnostic information. Like the interfaces 330 or 340 of the diagnostic device 2, these wired diagnostic interfaces 230 may comprise data ports, such as a USB port, an Ethernet port, and/or any other suitable serial or parallel port. Similarly, other wired interfaces 232 may also be provided for communication of information to and from the diagnostic device 2 and/or other devices. As an example, these wired interfaces 230, 232 may be used during pre-installation or factory testing of the receiver 4.

The receiver 4 may be powered by battery and/or another power supply 260, such as AC power from a power utility via an adapter, which may be coupled to a power conditioning module 262 as described above. Typically, the receiver 4 in automatic door control systems draws power from a power utility supply and has battery back-up in case of a power failure.

The receiver 4 may have more than one modes of operation. For example, the receiver 4 may default to an operational mode where it “listens” for and responds to signals transmitted by enrolled transmitters 6, 8 and the diagnostic device 2. The receiver 4 may also have a learn mode to enroll one or more transmitters 6, 8. The receiver 4 may be switched into the learn mode either by holding down a push-button for a preset interval (e.g. three seconds) until an LED indicator flashes, or upon receipt of a signal from the diagnostic device 2 instructing the receiver 4 to enter learn mode. The receiver 4 may return to operational mode automatically after a preset time delay, upon receiving a signal from the diagnostic device 2 indicating that enrollment is complete, or by depression of a push-button for a preset interval (e.g. three seconds) until an LED indicator flashes. The receiver 4 may also have other modes, such as for disassociating UIDs, updating firmware, etc.

In operational mode, upon receipt of a primary signal from a recognized transmitter 6 or 8, a control sequence to actuate the door is initiated. Following receipt of a primary signal from a transmitter 6, 8, the receiver 4 may transmit a signal, wirelessly or through a data port, for receipt by the diagnostic device 2 containing diagnostic information such as:
the number of operations or cycles of the receiver 4,
diagnostics-enabled and conventional transmitter primary transmission counts,
the number of activations by a particular UID,
the battery life and/or remaining battery life in one or more transmitters enrolled with the receiver 4,
temperature conditions of the receiver 4,
timeout conditions,
error codes,
received signal strength at the receiver 4 of the primary signal and secondary signal,
the serial number or UID of enrolled transmitters 6, 8,
the quality of transmitter 6, 8 installations based on the received signal quality and received signal strength indicator (RSSI) as an average or the average for each transmission frequency used in a frequency hopping system,
whether any bit error correction on the signal received from the transmitters 6, 8 was required and how many bits were corrected,
the modulation frequency of signals received by the receiver 4,
whether modulation frequency errors were detected in signals received by the receiver 4, and/or
any other diagnostic information that may be applicable and available in the signals received at the receiver 4.

Additionally, the diagnostic device 2 may collect the following diagnostic information from signals received from the transmitters 6, 8 and/or receiver 4:
the received signal strength at diagnostic device 2 of the signal transmitted by the receiver 4,
the serial number or UID of the transmitters 6, 8,
the quality of the transmitter 6, 8 installations based on the received signal quality,
whether any error correction on the received signal was required and how many bits were corrected,
the modulation frequency of signals received by the diagnostic device 2,
whether modulation frequency errors were detected in signals received by the diagnostic device 2, and/or
any other diagnostic information that may be applicable and available in the signals received at the diagnostic device 2.

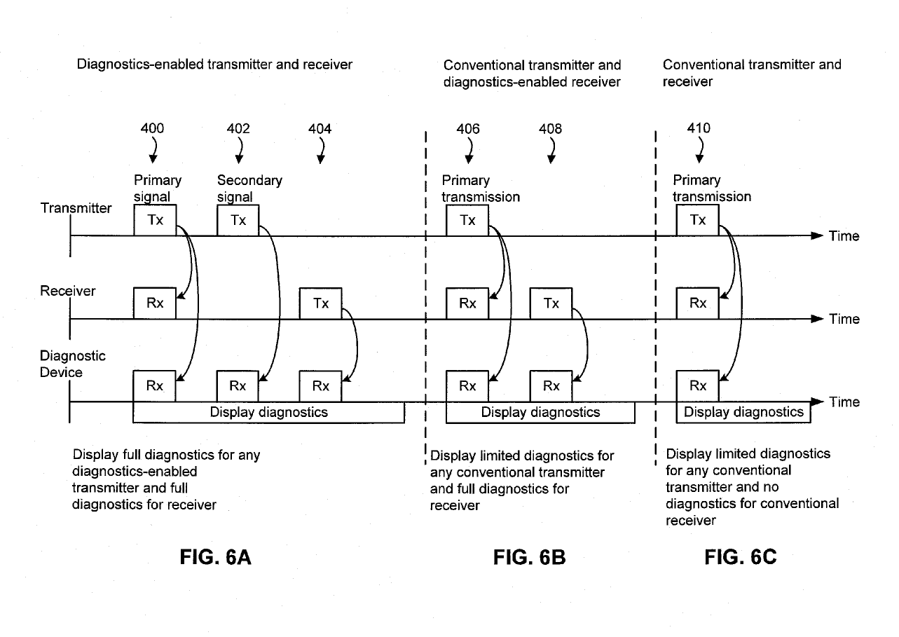

FIG. 6A illustrates the sequence of signals transmitted in an embodiment of a wireless door control system such as that shown in FIG. 1 upon activation by a diagnostics-enabled transmitter 6. After a primary signal is transmitted by the transmitter 6 and received by the receiver 4 and the diagnostic device 2 at 400, the transmitter 6 transmits and the diagnostic device 2 receives a secondary signal at 402. This secondary signal may optionally also be received by the receiver 4 (not shown). Following receipt of the primary transmission, the receiver 4 transmits a signal containing diagnostic information which may be received by the diagnostic device 2 at 404.

Where the wireless door control system is activated by a conventional transmitter 8, a primary signal is transmitted by the transmitter 8 and received by the receiver 4 and the diagnostic device 2 at 406, as shown in FIG. 6B. The receiver 4 then transmits a signal containing diagnostic information to the diagnostic device 2 at 408.

As shown in FIG. 6C, transmission of a primary signal by a conventional transmitter 8 of a wireless door control system such as that shown in FIG. 2 is received by both the receiver 14 and the diagnostic device 2. However, no diagnostic information is transmitted by the transmitter 8 or the receiver 14.

The diagnostic device 2 may be configured to display on a screen any available administrative and/or diagnostic information about a transmitter 6, 8. Administrative information may include UID, model type, name of user, group of users to which user belongs, receivers with which the UID is enrolled, etc. The transmitter information may be displayed according to user preferences set by the user. For example, the user may specify the layout of the information displayed, whether the most recent information is to be displayed, whether historical or cumulative information is to be displayed, and other parameters.

Similarly, the diagnostic device 2 may be configured to display on the screen any available administrative and/or diagnostic information about a receiver 4. Administrative information may include the serial number of the receiver 4, model type, location, UIDs enrolled, etc. The receiver information may be displayed according to user preferences set by the user, as described above.

All administrative and diagnostic information may be displayed on the screen of the diagnostic device 2 automatically, without user input, or may be displayed in response to user input. The information may also or alternatively be downloaded to a communication or data processing device and may be sent to a central location for monitoring.

The diagnostic device 2 may be implemented on a mobile communication device or a portable data processing device such as, without limitation, cellular phones, smartphones, wireless organizers, personal digital assistants, desktop computers, terminals, laptops, tablets, handheld wireless communication devices, wirelessly-enabled notebook computers and the like.

The diagnostic device 2 may also or alternatively be configured to provide other functions such as uploading software, loading new firmware into receivers 4, overriding hardware settings without compromising manual settings, interrogating receivers and/or transmitters by emulating devices, testing battery conditions, testing locations for interference and selectively enrolling and disassociating transmitter UIDs.

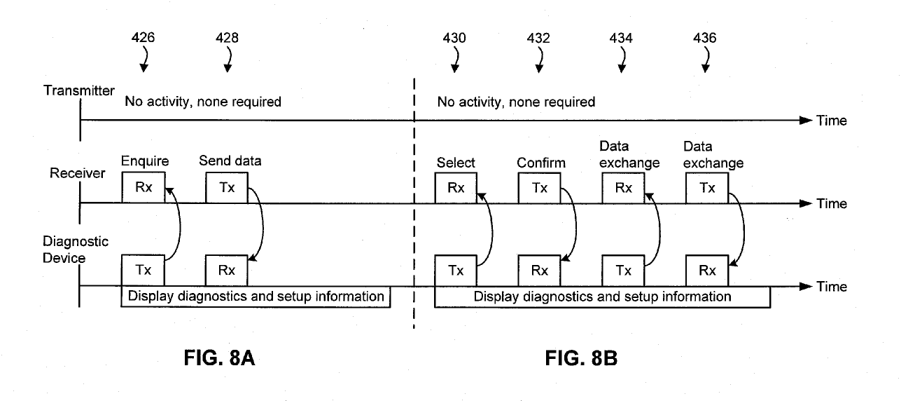

FIG. 8B illustrates the sequence of signals transmitted in an embodiment of a wireless door control system such as that shown in FIG. 1 to upload program information, such as firmware, to the receiver 4. The program information may be for the purposes of adding new features, installing upgrades, performing maintenance, or some other purpose. The user may first indicate which receiver 4 is to receive the upload. To do so, the user may, for example scroll to and select a menu option for loading firmware, displayed on the screen of the diagnostic device 2, using buttons or some other user input component. The user may then be presented with a list of receivers 4 within communication range of the diagnostic device 2 from which to choose. Upon selection of a receiver 4, the diagnostic device 2 may initiate a communication session with the selected receiver 4 at 430. Initiating a communication session may comprise transmitting a signal to put the receiver 4 into a mode to receive the upload. The receiver 4 may then transmit a signal to confirm receipt at 432 of the signal transmitted at 430 and/or that it is ready to receive the data. The diagnostic device 2 may then transmit some or all of the program information in a block of data to the receiver 4 at 434. Upon receipt of the block of data, the receiver 4 may then check for transmission errors; for example by performing a cyclic redundancy check (CRC) on the block of data received. If the CRC result is satisfactory, the receiver 4 may transmit a signal at 436 to the diagnostic device 2 to confirm that the block of data was received. If such confirmation is not received by the diagnostic device 2 after a period of time, the block of data may be resent. Steps 434 and 436 may be repeated until all of the program information is received.

Firmware or other program information may similarly be loaded onto diagnostics-enabled transmitters 4 that comprise a transceiver and are capable of bi-directional communication with the diagnostic device 2.

The diagnostic device 2 may initiate a communication session with a transmitter 6 or with a transceiver or receiver 4 for the purpose of modifying parameters that may normally be manually set in such devices. For example, door delays typically adjusted by potentiometer settings, operating modes typically set by pressing buttons and other features may alternatively be set using the diagnostic device 2, which may override any features that were manually set. When the manual setting have been overridden, they may be reinstated when the device is switched into learn mode, for example by pressing and holding a button for a preset interval (e.g. three seconds), or when the diagnostic device 2 sends a signal instructing the device to use the manual settings.

The diagnostic device 2 may also be configured to instruct the receiver 4 to activate relays (which causes actuation of the door) as part of the installation setup and test.

The diagnostic device 2 may initiate a communication session with the receiver 4 for the purpose of erasing (disassociating) and/or entering (enrolling) new UIDs, without having to erase all UIDs and re-enter several UIDs. For example, a receiver 4 capable of storing 40 UIDs could selectively be instructed to erase any specific UID, for example UID entry number 15, and a new transmitter could be enrolled in that location.

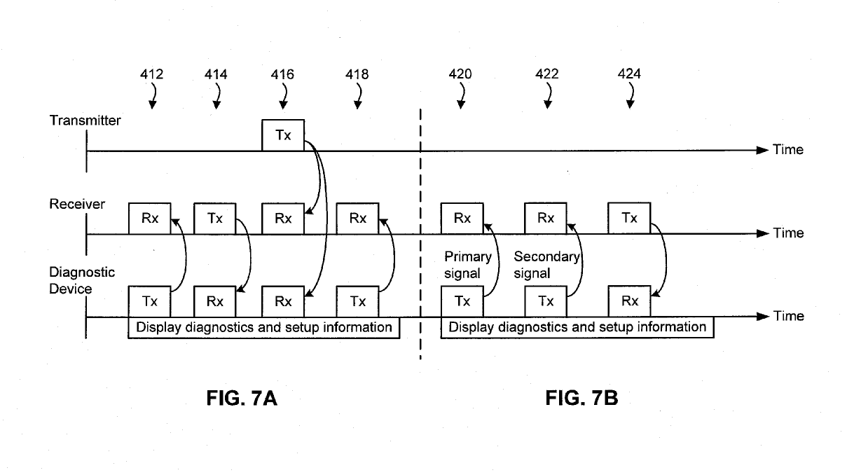

FIG. 7A illustrates the sequence of signals transmitted in an embodiment of a wireless door control system such as that shown in FIG. 1 to disassociate a transmitter 6, 8 from a receiver 4. As described above, the user may select which receiver 4 is to be addressed. The diagnostic device 2 may initiate a communication session with the selected receiver 4 by transmitting a signal to instruct the receiver 4 to enter a disassociation mode at 412, without requiring a user to physically push buttons on the receiver. The receiver 4 may then transmit a signal to indicate to the diagnostic device 2 that it is in the disassociation mode at 414. The diagnostic device 2 may indicate to the user that the receiver is ready to receive a signal from the transmitter 6, 8 to be disassociated for identification purposes. The primary signal transmitted upon activation of the appropriate push-button switch on the transmitter 6, 8 is received by the receiver 4 and the diagnostic device 2 at 416 to indicate which UID is to be erased. The diagnostic device 2 may then transmit a signal to the receiver 4 to confirm which UID was erased and/or instruct the receiver 4 to return to operational mode at 418. Alternatively, rather than erasing the UID the diagnostic device 2 may change the UID to an ‘inactive’ status.

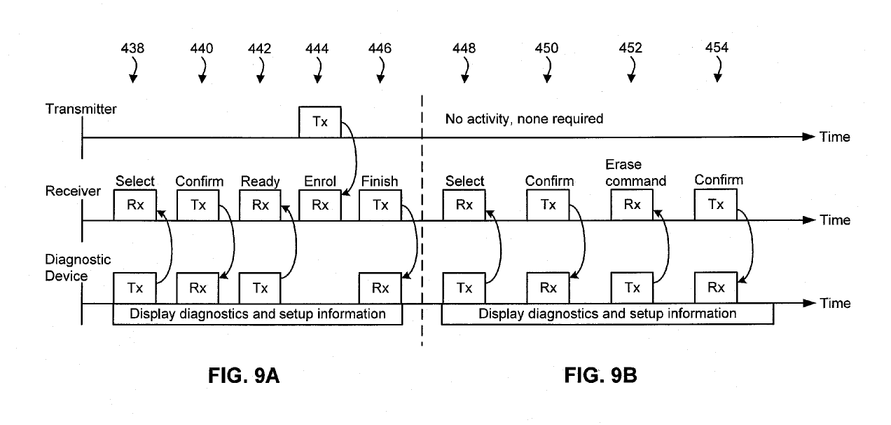

FIG. 9B illustrates the sequence of signals transmitted in an embodiment of a wireless door control system such as that shown in FIG. 1 to disassociate a transmitter 6, 8 from a receiver 4 without a primary signal from the transmitter 6, 8. The diagnostic device 2 may initiate a communication session with the selected receiver 4 by transmitting a signal to instruct the receiver 4 to enter a disassociation mode at 448, without requiring a user to physically push buttons on the receiver. The receiver 4 may then transmit a signal to indicate to the diagnostic device 2 that it is in the disassociation mode at 450. The diagnostic device 2 may then transmit a signal containing one or more UIDs to be dissociated at 452. The receiver 4 may then transmit a signal to the diagnostic device 2 to confirm that the UIDs were erased at 454. This function may be particularly useful when a transmitter 6, 8 is lost or stolen.

Similarly, as illustrated in FIG. 9A, the diagnostic device 2 may facilitate enrollment of a conventional transmitter 8 with a receiver 4. The diagnostic device 2 may initiate a communication session with the selected receiver 4 by transmitting a signal to instruct the receiver 4 to enter the learn mode at 438. The receiver 4 may then transmit a signal to confirm that it is in the learn mode at 440. The diagnostic device 2 may then transmit a signal to the receiver 4 to indicate that it is ready to receive the transmitter UID at 442. The primary signal transmitted upon activation of the main push-button switch on the transmitter 8 is received by the receiver 4 at 444 and the receiver 4 transmits the enrolled UID and optionally other information to the diagnostic device 2 at 446.

The diagnostic device 2 may be set to enter a mode in which it emulates diagnostics-enabled and conventional transmitter functions. Referring to FIG. 7B, the diagnostic device 2 may be configured to emulate a diagnostics-enabled transmitter 6 by transmitting a primary signal to be received by a receiver 4 at 420. In response to the primary signal, the receiver 4 initiates a control sequence to actuate the door. The diagnostic device 2 may then transmit a secondary signal, similar to that which would be transmitted by a transmitter 6, to be received by a receiver 4 at 422. In response to the primary signal, the receiver 4 may transmit a signal containing diagnostic information to be received by the diagnostic device 2 at 424. The diagnostic device 2 may emulate a conventional transmitter 8 in the same manner, except that a secondary signal is not transmitted. Diagnostic information received from the receiver 4 may be displayed by the diagnostic device 2.

The diagnostic device 2 may be set to continuously transmit a primary signal containing a preset UID, such that the receiver 4, 14 operation can be remotely tested by one person.

The diagnostic device 2 may be set to transmit degraded data such that the robustness of the receiver installation may be evaluated. Degraded transmissions may comprise data with known errors embedded, deviations from nominal RF and/or data transmission frequencies, or transmissions of data at lower or higher RF power levels.

The diagnostic device 2 may be set to enter a receiver emulation mode in which it emulates receiver functions. In this embodiment, the diagnostic device 2 may display any available transmitter 6, 8 and emulated receiver diagnostic information. This mode can be used offline (i.e., a non-operational mode) to test transmitters prior to installation or to troubleshoot and diagnose installations as simultaneous reception by the diagnostic device 2 and the installed transmitter 6, 8 of a transmitted signal, and the display of comparative data provides diagnostic information about most, if not all, signals of interest.

The diagnostic device 2 may initiate a communication session with the receiver 4 for the purpose of a diagnostic query, as illustrated in FIG. 8A. The diagnostic device 2 may transmit a signal for receipt by the receiver 4 at 426 to indicate what information is sought. In response, the receiver 4 may transmit the requested data to the diagnostic device 2 at 428. For example, the receiver 4 may report the number of received primary signals from any given transmitter that is enrolled, the average signal strength, and other diagnostic information. The diagnostic device 2 may query any diagnostics-enabled device. This mode can be used offline (i.e., a non-operational mode) to test diagiostics-enabled devices before and after installation.

As will be appreciated by those skilled in the art, the axes of time in FIGS. 6A to 9B are provided only for the purposes of illustration and are not intended to limit the described embodiments in any way. The sequences shown need not occur at time intervals proportional to those depicted in the figures and may in fact overlap in time.

In one embodiment, a diagnostic devices 2 with a single or multiple transceivers may be configured and set to listen for any and all signals in the frequency bands of interest to determine if a particular band is noisy or in use, i.e. to detect signal interference in frequency bands of interest. This interference detection function resembles the function of a portable, mobile spectrum analyzer. However this embodiment has additional functionality as a diagnostic device 2. The diagnostic device 2 may be configured to present the user with a graphical user interface (GUI) for selection of a frequency band. Upon selection of a frequency band, the diagnostic device may measure, record and display the amount of interference detected by the diagnostic device 2.

In one embodiment, the diagnostic device 2 may be provided with a simple user interface that provides basic information for use in validating an installation. For example, key functions may be used to emulate a transmitter 6, 8 with a single push button, and received signal strengths may be indicated by an array of three LEDs or a single flashing LED. Any combination of user interface subsystems may be used and will be apparent to one skilled in the art having regard to the description above. This embodiment of the diagnostic device 2 may also be wireless so that the installer can operate the door control system for testing and troubleshooting at a distance from the receiver 4, 14.

In another embodiment, the diagnostic device 2 may comprise an LED or multi-coloured LEDs at the end of a long cable to remotely indicate pass/fail criteria for an installation of a diagnostics-enabled receiver 4. As an example, where the diagnostic device 2 comprises a single LED, the strength of the signal received from a transmitter 6, 8 may be indicated by number of flashes of the LED, such as multiple (for example three) flashes for a strong signal and a single flash for a weak signal.

By providing diagnostic information about transmitters 6, 8, the diagnostic device 2 enables testing and validation of the transmitters before and after installation. Testing and validation before installation ensures that only fully functional transmitters are installed. Once transmitters are installed, they may be tested to verify the quality of the installation, and problems such as low battery power can be diagnosed without the need to reopen the installation. By providing diagnostic information about a receiver 4, 14, the diagnostic device 2 provides the ability to fully measure and test a diagnostics-enabled receiver's operation and to test a subset of parameters for conventional receivers 14, before and after an installation.

Diagnostic information collected at a receiver 4 of signals transmitted from diagnostic-enabled transmitters 6 and conventional transmitters 8 thus provides for system end-to-end test capability.

Installer safety is thus enhanced and system down-time is reduced as diagnostic device functions reduce the need to reopen receiver installations for diagnostic purposes and diagnostic information is provided quickly in a user-friendly format.

Various embodiments of the present invention having been thus described in detail by way of example, it will be apparent to those skilled in the art that variations and modifications may be made without departing from the invention. The invention includes all such variations and modifications as fall within the scope of the appended claims.

What is claimed is:

1. A diagnostic device for use in wireless door control systems comprising at least one receiver for receiving from a transmitter a primary signal comprising a unique identifier associated with the transmitter to initiate a door control sequence, the device comprising a communication interface for receiving diagnostic information from a receiver, at least one transmitter, or both, the communication interface being in communication with a user interface for conveying information comprising the diagnostic information to a user.

2. The diagnostic device of claim 1, wherein the communication interface comprises a wireless communication interface for wireless communication with the receiver, at least one of the at least one transmitters, or a communication device.

3. The diagnostic device of claim 2, wherein the user interface comprises a display screen for displaying the information to be conveyed to the user, the diagnostic device further comprising:
memory for storing diagnostic information received from the receiver, at least one of the at least one transmitters, or the receiver and one or more of the transmitters; and
a processor for processing the diagnostic information stored in memory for display on the display screen.

4. The diagnostic device of claim 3 when the communication interface is for receiving diagnostic information from at least one of the at least one transmitters,
wherein the diagnostic information is received in a secondary signal from one of the at least one transmitters, and
wherein the diagnostic information contained in the secondary signal comprises one or more of: the number of operations of the one of the transmitters, battery life, remaining battery life, temperature conditions of the one of the transmitters, timeout conditions or error codes.

5. The diagnostic device of claim 3 wherein the communication interface is for receiving diagnostic information from a receiver, wherein the diagnostic information from the receiver comprises one or a combination of: the number of operations of the diagnostics-enabled receiver, transmitter primary transmission counts, the number of activations by a particular transmitter, the battery life and remaining battery life in one or more transmitters enrolled with the receiver, temperature conditions of the diagnostics-enabled receiver, timeout conditions, error codes, received signal strength at the receiver of the primary signals and secondary signals from transmitters, the unique identifiers of enrolled transmitters, the quality of transmitter installations based on the received signal quality and received signal strength indicator, any error correction, the modulation frequency of signals received by the diagnostics-enabled receiver, or whether modulation frequency errors were detected in signals received by the diagnostics-enabled receiver.

6. The diagnostic device of claim 3, wherein the diagnostic information stored in memory and displayed on the display screen further comprises one or more of: the signal strength received at the diagnostic device of the signal transmitted by the receiver, the unique identifiers of the at least one transmitter enrolled at the receiver, the quality of transmitter and receiver installations based on the quality of signals received at the diagnostic device, any error correction, the modulation frequency of signals received by the diagnostic device, or whether modulation frequency errors were detected in signals received by the diagnostic device.

7. The diagnostic device of claim 1, wherein the communication interface comprises a wired communication interface for communication with the receiver, at least one of the at least one transmitters, or a communication device.

8. The diagnostic device of claim 2, wherein the communication interface is capable of transmitting signals for receipt by the receiver and the diagnostic device is configured to emulate a transmitter of the at least one transmitters by transmitting a primary signal comprising at least the unique identifier of the emulated transmitter and to transmit a secondary signal comprising at least diagnostic information relating to the emulated transmitter for receipt by a receiver at which the emulated transmitter is enrolled.

9. The diagnostic device of claim 8, wherein the communication interface is configured to transmit degraded signals.

10. A transmitter for use in wireless door control systems comprising at least one receiver for receiving from a transmitter a primary signal comprising a unique identifier associated with the transmitter to initiate a door control sequence, the transmitter comprising:
a communication interface for transmission of the primary signal and a secondary signal comprising at least diagnostic information relating to the transmitter upon activation of a switch; and
a user interface for activation of the switch.

11. The transmitter of claim 10, wherein the communication interface comprises
a wireless communication interface for wireless transmission of the primary signal; and
a wired communication interface for communication with the receiver, a diagnostic device for conveying information comprising the diagnostic information to a user, a communication device, or any combination thereof.

12. The transmitter of claim 10, wherein the communication interface is configured to receive data from a diagnostic device or a communication device, or both.

13. A receiver for use in wireless door control systems comprising at least one receiver for receiving from a transmitter a primary signal for initiating a door control sequence when the transmitter is enrolled at the receiver, the primary signal comprising a unique identifier associated with the transmitter, the receiver comprising:
a communication interface for receiving the primary signal and for transmitting a signal comprising at least diagnostic information relating to the receiver to a diagnostic device for conveying information comprising the diagnostic information to a user; and
at least one relay for actuation of a door control sequence upon detection by the receiver of the primary signal from the transmitter.

14. The receiver of claim 13, wherein the communication interface comprises a wireless communication interface for receiving the primary signal.

15. The receiver of claim 14, wherein the communication interface comprises a wired communication interface for communication with the transmitter, a diagnostic device for conveying information comprising the diagnostic information to a user, a communication device or any combination thereof.

16. A method of displaying on a display screen of a diagnostic device diagnostic information relating to a wireless door control system comprising at least one receiver for receiving from a transmitter a primary signal to initiate a door control sequence, the primary signal comprising a unique identifier associated with the transmitter, the method comprising:
the diagnostic device receiving a signal comprising diagnostic information from a receiver or a transmitter;
extracting from the signal the diagnostic information;
storing the diagnostic information in memory; and
displaying on the display screen of the diagnostic device at least some of the diagnostic information.

17. The method of claim 16 further comprising
generating additional diagnostic information, wherein the additional diagnostic information comprises one or more of: the signal strength received at the diagnostic device of the signal transmitted by the receiver, the quality of transmitter and receiver installations based on the quality of signals received at the diagnostic device, any error correction, the modulation frequency of signals received by the diagnostic device, or whether modulation frequency errors were detected in signals received by the diagnostic device;
storing the additional diagnostic information in the memory; and,
displaying on the display screen of the diagnostic device at least some of the additional diagnostic information.

18. The method of claim 16 further comprising, before the step of receiving a signal comprising diagnostic information at a communication interface:
transmitting from the transmitter or the receiver a signal comprising a request for diagnostic information.

19. The method of claim 16 wherein the signal comprising diagnostic information is received in response to the diagnostic device emulating a transmitter by
transmitting a primary signal comprising at least the unique identifier of the emulated transmitter, and
transmitting a secondary signal comprising at least diagnostic information relating to the emulated transmitter.

20. A method of disassociating at least one of a plurality of transmitters from a receiver of a wireless door control system, the method comprising:
transmitting a signal instructing the receiver to enter a disassociating mode for disassociating a particular transmitter of the plurality of transmitters from the receiver;
receiving at the diagnostic device a signal from the receiver containing confirmation that the receiver is in the disassociating mode;
transmitting to the receiver a signal containing unique identifiers associated with each transmitter to be disassociated from the receiver; and
receiving at the diagnostic device a signal from the receiver containing confirmation that the unique identifiers associated with each transmitter to be disassociated from the receiver were erased or inactivated.
